(19) United States
(12) Patent Application Publication
(10) Pub. No.: US 2025/0348203 A1
(43) Pub. Date: Nov. 13, 2025

(54) ENHANCING HUMAN-MACHINE INTERACTION WITH DYNAMIC CHUNKING AND SMART LOADING FOR NEXT GENERATION USER EXPERIENCES

(71) Applicant: SAP SE, Walldorf (DE)

(72) Inventor: Lamine Rihani, Sartrouville (FR)

(21) Appl. No.: 18/812,717

(22) Filed: Aug. 22, 2024

Related U.S. Application Data
(60) Provisional application No. 63/643,533, filed on May 7, 2024.

(51) Int. Cl. G06F 3/0485; G06F 9/451

(52) U.S. Cl. CPC G06F 3/0485; G06F 9/451

(57) ABSTRACT

The present disclosure involves systems, software, and computer implemented methods for dynamic data chunking and intelligent lazy loading. An example method includes determining a scrolling velocity of a user interacting with a graphical user interface that is displaying a first data portion of a data set. A size is determined, of a second portion to retrieve, based at least on the scrolling velocity. A first request is sent to retrieve the second portion of the data set. The second portion is received and at least a portion of the second portion is included in the interface. A threshold portion of the second portion is determined at which to send a second request. A determination is made that the user has scrolled the interface such that at least the threshold portion of the second portion is displayed. The second request is sent to retrieve a third portion of the data set.

### CLAIM OF PRIORITY

This application claims priority under 35 USC § 119(e) to U.S. Provisional Patent Application Ser. No. 63/643,533, filed on May 7, 2024, the entire contents of which are hereby incorporated by reference.

### TECHNICAL FIELD

The present disclosure relates to computer-implemented methods, software, and systems for improved user interfaces.

### BACKGROUND

A cloud application can include a client portion that includes a user interface and an ability to request data from the cloud from a server portion. The client portion can request data, receive requested data, and display received data in the user interface.

### SUMMARY

The present disclosure involves systems, software, and computer implemented methods for dynamic data chunking and intelligent lazy loading. An example method includes: determining a scrolling velocity of a user interacting with a graphical user interface that is displaying a first data portion of a data set retrieved over a connection from a data source; determining a size of a second data portion to retrieve from the data source based at least on the scrolling velocity; sending a first data request to retrieve the second data portion of the data set, wherein the first data request specifies the size of the second data portion; receiving the second data portion of the data set in response to the first data request; including at least a portion of the second data portion of the data set in the graphical user interface; determining a threshold portion of the second data portion of the data set at which to send a second data request; determining that the user has scrolled the graphical user interface such that at least the threshold portion of the second data portion is displayed; and sending the second data request to retrieve a third data portion of the data set.

Implementations may include one or more of the following features. The scrolling velocity can be determined based on a current scroll position in the graphical user interface, a previous scroll position, a current timestamp at which the current scroll position is determined, and a previous timestamp at which the previous scroll position is determined. The size of the second data portion can be determined based on the scrolling velocity, a minimum data portion size, a maximum data portion size, and at least one characteristic of the data source or the connection. A first characteristic of the data source can be a data source location, a database type, a server type, or a storage technology. A first characteristic of the connection can be a connection type, a network type, or a device type of a receiving device. The size of the second data portion can be determined based on a smoothing factor applied to the scrolling velocity. The smoothing factor can be a logarithmic function. The threshold portion of the second data portion can be determined based on a minimum threshold, the size of the second data portion, the scrolling velocity, and a user behavior monitoring time interval. User behavior can be monitored and the scrolling velocity of the user can be updated to an updated scrolling velocity. A size of the third data portion can be determined based at least on the updated scrolling velocity and the size of the third data portion can be include in the second data request.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for dynamic data chunking and intelligent lazy loading.

FIG. 2A illustrates a formula for determining a scrolling velocity.

FIG. 2B illustrates a formula for determining a chunk size.

FIG. 2C illustrates a formula for determining a threshold value at which to request a next data chunk.

FIG. 3 illustrates example actions that may occur during application loading.

FIG. 4 illustrates example pseudocode for application loading.

FIG. 5 illustrates example ongoing actions that can occur after an application has loaded.

FIG. 6 illustrates example pseudocode that describes code that may be executed after an application has loaded

FIG. 7 is a flowchart of an example method for dynamic data chunking and intelligent lazy loading.

### DETAILED DESCRIPTION

In today's digital age, seamless human-machine interaction is important for delivering a satisfactory user experience. As more data-driven applications are being developed, there is a need to handle large amounts of data and complex structures. However, traditional approaches to data loading can result in slow and unresponsive interfaces, which can be frustrating for users and negatively impact user productivity. One key issue with traditional data loading approaches is a lack of optimization. For instance, loading of all data at once can cause performance issues and consume a large amount of resources. Traditional data loading techniques, for example, typically load all the data for an application at once or with a fixed data chunk size, which can result in slow loading times, high resource consumption, and poor user experience. Slow loading times can be particularly problematic for applications that allow users to interact with data through a user interface where the amount of data displayed to the user at any given time can greatly impact the user experience. Another issue with traditional approaches to data loading is that the traditional approaches do not consider user behavior or data type(s) of loaded data. For instance, user behavior can vary widely and loading all data at once may not be necessary or desirable for all users. As another example, different types of data may require different approaches to loading and display.

To solve the problems discussed above, an improved data loading system can be used that automatically and dynamically considers the user's behavior and requested data type. The improved data loading system can thus use dynamic, optimized lazy loading with smart data chunking for improving performance and user experience. The improved data loading system loading data on demand can improve performance and reduce resource consumption, resulting in faster, more responsive interfaces. The improved data loading approach can be applied to various types of data-driven applications, such as data selection components and user scrolling within any content. The improved data loading approach can result in faster, more responsive interfaces that adapt to user needs and preferences.

In one example system, the solution may be represented or implemented as a smart service associated with a user interface or user experience system. The smart service can be used to monitor user behavior, such as interactions with a particular data set. The smart service, or another component, can obtain information from the UI regarding the system in which the user is interacting, the user's interactions with the UI (e.g., a scrolling speed), and, in some cases, information about the data source, the device on which the user is operating, the type of data source being accessed, and the type of connectivity. Based on that information, the smart service can determine an amount of information to be obtained, and when, while the user scrolls or moves through the information. The request for a particular amount of information can be based on a threshold, and when that threshold is met, a request can be provided to a data access component, or data service, which can then perform the operations to pull or otherwise retrieve the data from the corresponding data source (e.g., an in-memory system, a legacy database, etc.). The smart service can be used in connection with any suitable application with which the UI is associated.

In further detail regarding specific technical advantages, the improved data loading technique can save computing resources and network bandwidth by generally transferring less data than other approaches. For instance, backend resources can be efficiently utilized by loading data in smaller chunks as needed and reducing unnecessary data pulls. Such an approach can ensure that only required data is retrieved (e.g., data the user would not scroll to is not retrieved, thus saving data requests and overall data retrieval and transfer). Sending smaller and fewer data requests results in reduced server load. Additionally, with smart lazy loading, unnecessary data requests and network traffic can be minimized. By retrieving data in smaller, targeted chunks, the solution reduces the amount of data processed by backend systems, transferred over the network, and processed by receiving devices.

Such lazy loading not only improves performance but also helps in optimizing bandwidth usage, especially in bandwidth-constrained environments. For instance, the solution improves performance in low-bandwidth environments by incrementally loading data and reducing initial loading time. The solution is particularly advantageous in scenarios where users have slow internet connections or limited bandwidth, since loading data incrementally and on-demand reduces the initial loading time and provides a smoother experience even in challenging network conditions.

Furthermore, the improved data loading system can result in improved backend/server balancing. Since requesting full data sets is avoided, the backend systems receive smaller data requests, and can thus perform better load balancing, handle a higher number of concurrent requests, etc. By loading data dynamically and on demand, the techniques described herein reduce the load on backend resources, enabling backend servers to better balance and handle overall system load since user devices are not requesting large amounts of data all at once.

The improved solution is also highly scalable. For instance, the solution can handle large datasets with ease, accommodating varying data sizes without compromising performance. By dynamically adjusting a chunk size and threshold point at which additional chunks are retrieved, the solution can efficiently accommodate datasets of varying sizes without sacrificing performance. This scalability is particularly beneficial in applications that deal with rapidly growing or changing data.

In general, the solution is customizable and adaptable. For instance, input parameters such as data source type, scrolling velocity, and data content size can allow for customization and adaptation. For instance, the flexibility enabled by the input parameters can allow for customization and adaptability to different scenarios and user requirements. The solution can be fine-tuned based on specific application needs, ensuring optimal performance and responsiveness in different situations. Furthermore, the dynamic chunking and smart lazy loading approach is designed to adapt to evolving user needs and changing data landscapes by providing the ability to fine-tune parameters and algorithms and provide adaptability that can evolve alongside other technological advancements.

The above-described benefits provide multiple advantages over other approaches such as legacy solutions. Legacy solutions, for example, can often struggle to efficiently load large and/or complex data sets. Legacy solutions are often not optimized for modern data-driven applications that require fast, responsive interfaces that adapt to user needs and preferences. Accordingly, such legacy solutions often result in suboptimal user experience and lost productivity. The improved solution addresses these shortfalls of legacy systems by providing a dynamic and optimized approach that considers the user's behavior and requested data type to deliver a seamless user experience.

Various aspects of the solution combine to provide seamless user experiences with respect to data loading in various types of application scenarios. For instance, the user does not need to wait to begin interacting with data since only a portion of application-requested data is initially retrieved. Users can start interacting with a manageable portion of data even when all data initially requested has not yet been completely loaded. Users need not be aware of an overall size of a data request, since subsets of data are retrieved on an as-needed basis. Accordingly, user interaction interruption and delay can be reduced or eliminated as a user is not waiting for a full data set to load. In summary with regards to seamless experiences, the dynamic chunking and smart lazy loading approach described herein significantly enhances the user experience by providing faster and more responsive interfaces. By loading data on demand and adapting the chunk size and threshold based on user behavior, users can seamlessly navigate through large datasets without experiencing delays or interruptions. Furthermore, users can be provided with a notification or choice about user behavior monitoring and subsequent system response, and can opt out of such monitoring if desired.

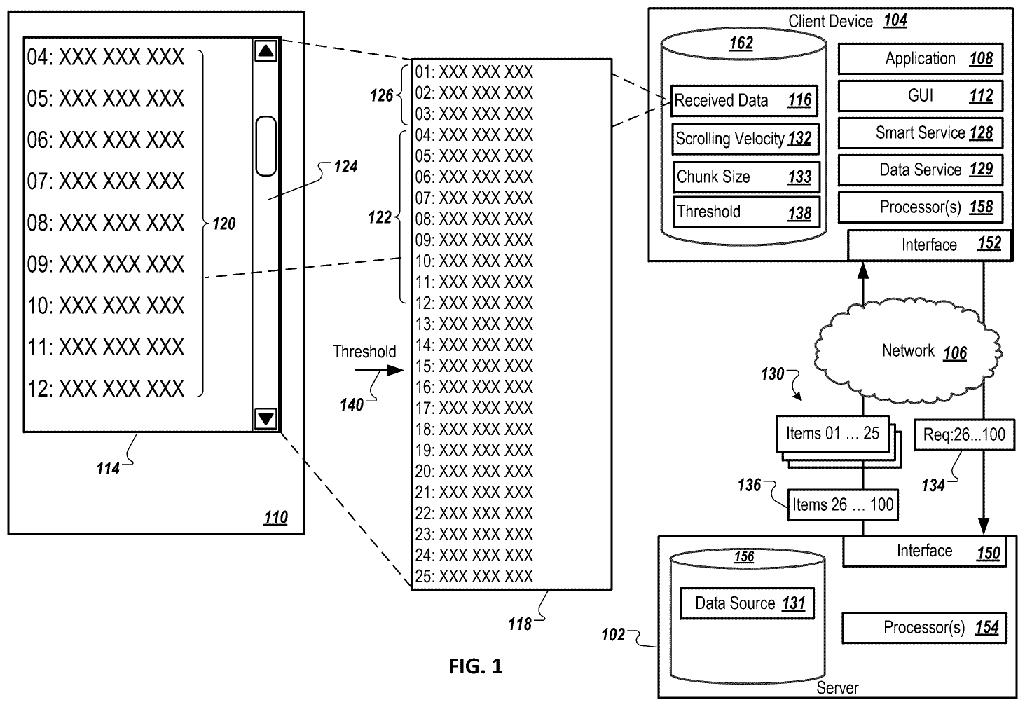

FIG. 1 is a block diagram illustrating an example system 100 for dynamic data chunking and intelligent lazy loading. Specifically, the illustrated system 100 includes or is communicably coupled with a server 102 (e.g., a backend system), a client device 104, and a network 106. Although shown separately, in some implementations, functionality of two or more systems or servers may be provided by a single system or server. In some implementations, the functionality of one illustrated system, server, or component may be provided by multiple systems, servers, or components, respectively.

An application 108 runs on the client device 104. The application 108 has a user interface 110 that is displayed on a GUI (Graphical User Interface) 112 of the client device 104. The user interface 110 includes a scrollable area 114.

The scrollable area 114 as shown displays an example number of numbered items for convenience of illustration and discussion, but in practice, the scrollable area 114 can be used to view a larger number of items and/or different types of content. For instance, the application 108 generally and the scrollable area 114 specifically can be used to display data selection components (e.g., member selectors), dropdown menus, list boxes, search bars and search result displays in data-driven applications, tables and charts displaying large datasets, dynamic content loading (e.g., continual scrolling or paginated content), image galleries and other media-rich applications, real-time data streams and dashboards, or any application dealing with large datasets or complex data structures.

The scrollable area 114 displays data received by the client device 104 from the server 102 (or another backend system). For instance, the client device 104 currently stores received data 116. As shown in example data 118, the received data includes items numbered 01, 02, . . . , 25. The scrollable area 114 can display a portion of the received data 116. For instance, the scrollable area 114 currently displays items 04, 05, . . . 12 (e.g., as shown by displayed items 120 and a corresponding portion 122 of the example data 118).

The user can scroll the scrollable area 114 (e.g., using a scroll bar 124, using touch inputs, or using some other scrolling technique). For example, the user has scrolled past items numbered 01, 02, and 03 (e.g., corresponding to a portion 126 of the example data 118). The user can continue to scroll the scrollable area 114 to view some or all of the remainder of the items in the example data 118 (e.g., items numbered 13, 14, . . . , 25).

As described in more detail below, the application 108 can be configured to use one or more services (e.g., a smart service 128 and a data service 129) to implement a smart lazy loading technique to efficiently load and display data using multiple data fetches for data from the server 102. For example, the received data 116 received thus far from the server 102 for the application 108 may have been received using one or more data retrievals 130 from a data source 131 (e.g., received in response to one or more corresponding data requests). Although the data source 131 is shown as included in the server 102, the data source 131 may reside in other locations.

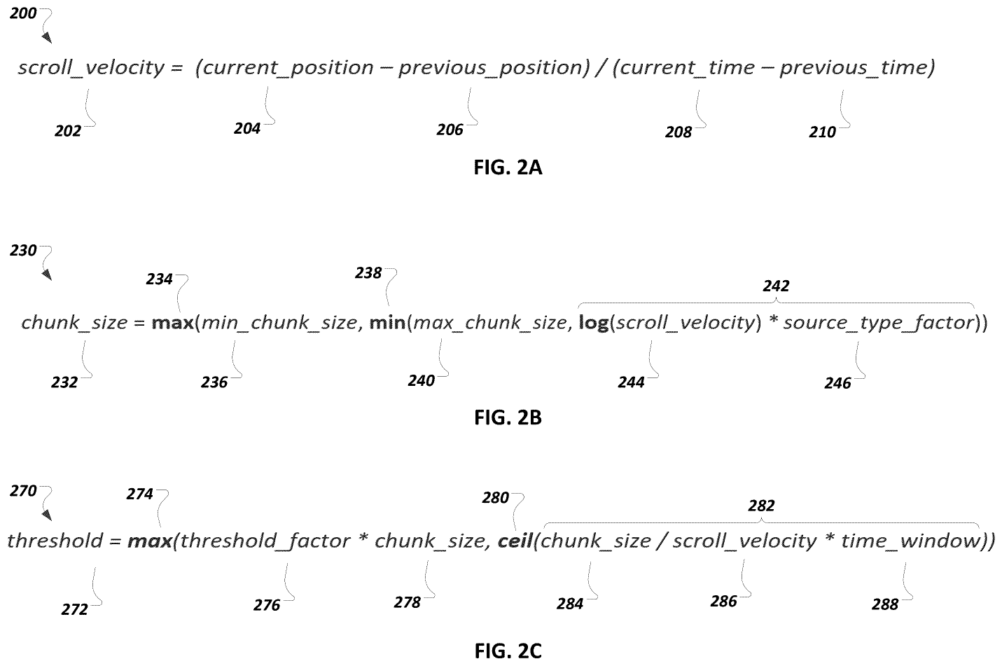

The smart service 128 can monitor and determine a scrolling velocity 132 of the user (e.g., when the user is interacting with the scrollable area 114 or when the scrollable area 114 has focus). The scrolling velocity 132 can indicate a speed at which the user is trying to navigate through the scrollable area 114, for example. The scrolling velocity 132 can be expressed, for example, in pixels per second. Further details regarding approaches the smart service 128 can use to calculate the scrolling velocity 132 are described below with respect to FIG. 2A.

By measuring the scrolling velocity 132, the system can determine how quickly the user is scrolling and adjust data loading accordingly. For example, if the scrolling velocity 132 is higher, the system can load data more aggressively to keep up with the user's scrolling speed. As another example, if the scrolling velocity 132 is lower, the system can reduce the amount of data loaded to conserve resources and improve performance.

The smart service 128 can calculate a chunk size 133 to control an amount or size of data fetched at a time based, in part, on the scrolling velocity 132. Details on approaches and calculations that the smart service 128 may use to calculate the chunk size 133 are described in more detail below with respect to FIG. 2B. For instance, in addition to the scrolling velocity 132, the smart service 128 can consider, when calculating the chunk size 133, aspects of the data source and corresponding connection, such as database type, connection speed, etc.

In the example of FIG. 1, a next data request 134 (e.g., next data fetch) is for a next seventy five items. For instance, a current value of the scrolling velocity 132 may be higher than previous calculations of the scrolling velocity 132 (e.g., indicating the user is now scrolling faster than before) and correspondingly, the smart service 128 can calculate the chunk size 133 to be a value of seventy five that is higher than previous chunk sizes, so that a larger amount of data (e.g., requested data 136 including items numbered 26, 27, . . . , 100) can be fetched and rendered so that the scrollable area 114 has more data available for the user to scroll through at the now higher scrolling velocity.

The smart service 128 can determine a threshold value 138 that represents a point in currently-displayed data at which to request a next data chunk when the user scrolls to that point in the currently-displayed data. The threshold 138 can be based on the scrolling velocity 132 and other factors, as described in more detail below with respect to FIG. 2C.

As an example, when the portion 122 of the received data 116 (e.g., corresponding to numbered items 04, 05, . . . , 12) is displayed in the scrollable area 114, the smart service 128 may have calculated the threshold value 138 to correspond to the item numbered 15 (e.g., as illustrated by a marker 140). The client device 104 can send the next data request 134 in response to the user scrolling the scrollable area 114 so that the item numbered 15 is visible.

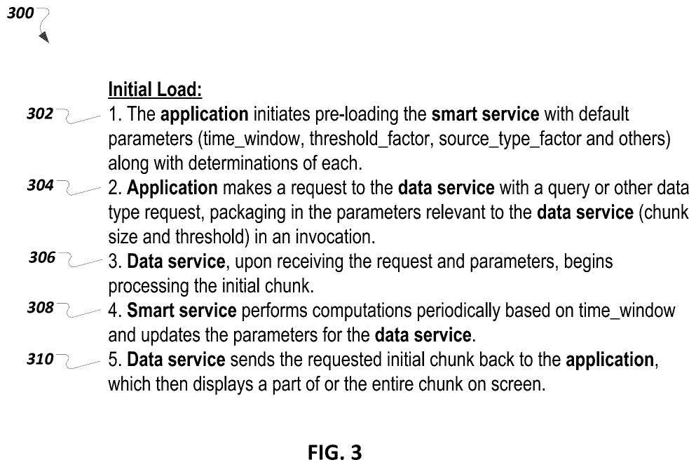

FIGS. 3-6 below provide further details regarding configuration of and actions of the application 108 in conjunction with the smart service 128 and the data service 129, for providing the described dynamic data chunking and intelligent lazy loading.

As used in the present disclosure, the term “computer” is intended to encompass any suitable processing device. For example, although FIG. 1 illustrates a single server 102, and a single client device 104, the system 100 can be implemented using a single, stand-alone computing device, two or more servers 102, or two or more client devices 104. Indeed, the server 102 and the client device 104 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server 102 and the client device 104 may be adapted to execute any operating system, including Linux, UNIX, Windows, Mac OS®, Java™, Android™, iOS or any other suitable operating system. According to one implementation, the server 102 may also include or be communicably coupled with an e-mail server, a Web server, a caching server, a streaming data server, and/or other suitable server.

Interfaces 150 and 152 are used by the client device 104 and the server 102, respectively, for communicating with other systems in a distributed environment—including within the system 100—connected to the network 106. Generally, the interfaces 150 and 152 each comprise logic encoded in software and/or hardware in a suitable combination and operable to communicate with the network 106. More specifically, the interfaces 150 and 152 may each comprise software supporting one or more communication protocols associated with communications such that the network 106 or interface's hardware is operable to communicate physical signals within and outside of the illustrated system 100.

The server 102 includes one or more processors 154. Each processor 154 may be a central processing unit (CPU), a blade, an application specific integrated circuit (ASIC), a field-programmable gate array (FPGA), or another suitable component. Generally, each processor 154 executes instructions and manipulates data to perform the operations of the server 102. Specifically, each processor 154 executes the functionality required to receive and respond to requests from the client device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The server 102 includes memory 156. In some implementations, the server 102 includes multiple memories. The memory 156 may include any type of memory or database module and may take the form of volatile and/or non-volatile memory including, without limitation, magnetic media, optical media, random access memory (RAM), read-only memory (ROM), removable media, or any other suitable local or remote memory component. The memory 156 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server 102.

The client device 104 may generally be any computing device operable to connect to or communicate with the server 102 via the network 106 using a wireline or wireless connection. In general, the client device 104 comprises an electronic computer device operable to receive, transmit, process, and store any appropriate data associated with the system 100 of FIG. 1. The client device 104 can include one or more client applications, including the application 108. A client application is any type of application that allows the client device 104 to request and view content on the client device 104. In some implementations, a client application can use parameters, metadata, and other information received at launch to access a particular set of data from the server 102. In some instances, a client application may be an agent or client-side version of the one or more enterprise applications running on an enterprise server (not shown).

The client device 104 further includes one or more processors 158. Each processor 158 included in the client device 104 may be a central processing unit (CPU), an application specific integrated circuit (ASIC), a field-programmable gate array (FPGA), or another suitable component. Generally, each processor 158 included in the client device 104 executes instructions and manipulates data to perform the operations of the client device 104. Specifically, each processor 158 included in the client device 104 executes the functionality required to send requests to the server 102 and to receive and process responses from the server 102.

The client device 104 is generally intended to encompass any client computing device such as a laptop/notebook computer, wireless data port, smart phone, personal data assistant (PDA), tablet computing device, one or more processors within these devices, or any other suitable processing device. For example, the client device 104 may comprise a computer that includes an input device, such as a keypad, touch screen, or other device that can accept user information, and an output device that conveys information associated with the operation of the server 102, or the client device 104 itself, including digital data, visual information, or the GUI 112.

The GUI 112 of the client device 104 interfaces with at least a portion of the system 100 for any suitable purpose, including generating a visual representation of the application 108. In particular, the GUI 112 may be used to view and navigate various Web pages, or other user interfaces. Generally, the GUI 112 provides the user with an efficient and user-friendly presentation of business data provided by or communicated within the system. The GUI 112 may comprise a plurality of customizable frames or views having interactive fields, pull-down lists, and buttons operated by the user. The GUI 112 contemplates any suitable graphical user interface, such as a combination of a generic web browser, intelligent engine, and command line interface (CLI) that processes information and efficiently presents the results to the user visually.

Memory 162 included in the client device 104 may include any memory or database module and may take the form of volatile or non-volatile memory including, without limitation, magnetic media, optical media, random access memory (RAM), read-only memory (ROM), removable media, or any other suitable local or remote memory component. The memory 162 may store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client device 104.

There may be any number of client devices 104 associated with, or external to, the system 100. For example, while the illustrated system 100 includes one client device 104, alternative implementations of the system 100 may include multiple client devices 104 communicably coupled to the server 102 and/or the network 106, or any other number suitable to the purposes of the system 100. Additionally, there may also be one or more additional client devices 104 external to the illustrated portion of system 100 that are capable of interacting with the system 100 via the network 106. Further, the term “client”, “client device” and “user” may be used interchangeably as appropriate without departing from the scope of this disclosure. Moreover, while the client device 104 is described in terms of being used by a single user, this disclosure contemplates that many users may use one computer, or that one user may use multiple computers.

FIG. 2A illustrates a formula 200 for determining a scrolling velocity 202. The scrolling velocity 202, which represents a speed at which the user scrolls a user interface, can be measured in pixels per second, for example. The smart service 128 of FIG. 1 can determine the scrolling velocity 202 by calculating a first difference between a current position 204 and a previous position 206, a second difference between a current time 208 and a previous time 210, and then dividing the first difference by the second difference. The current position 204 is a current scroll position, the previous position 206 is a previous scroll position (e.g., from a previous frame), the current time 208 is a time of a current measurement (e.g., of the current position 204), and the previous time 210 is a time of a previous measurement (e.g., of the previous position 206).

FIG. 2B illustrates a formula 230 for determining a chunk size 232. The chunk size 232 can refer to a number of data items that can be loaded at a time. The smart service 128 of FIG. 1 can determine the chunk size 232 by using a maximum function 234 that determines a maximum of a first parameter and a second parameter. The first parameter evaluated by the maximum function 234 is a minimum chunk size 236 which is a predetermined value representing a minimum number of data items to load per chunk. The second parameter evaluated by the maximum function 234 is a result of a minimum function 238 that determines a minimum value of a first parameter and a second parameter. The first parameter evaluated by the minimum function 238 is a maximum chunk size 240 that is a predetermined value that represents a maximum number of data items to load per chunk. The minimum chunk size 236 can be used to avoid situations in which a chunk size is calculated (e.g., one item) that would be too small for efficient operations. The maximum chunk size 240 can represent a maximum number of items a user may be expected to scroll to or through in a fastest set of scrolling operations in a short time period, for example. The minimum chunk size 236 and maximum chunk size 240 may be predetermined values or may be computed dynamically using respective functions.

The second parameter evaluated by the minimum function 238 is an expression 242 that includes a logarithmic calculation of a scrolling velocity 244 (which can be the scrolling velocity 202 described above with respect to FIG. 2A) multiplied by a source type factor 246. A logarithmic calculation of the scrolling velocity 244 can be used when determining the chunk size 232 rather than the scrolling velocity 244 itself as a smoothing approach.

The source type factor 246 represents a relative speed at which data can be retrieved from a data source being used. The source type factor 246 can have a value from between zero and one, which a value of one indicating a fastest data retrieval speed. As an example, a source type factor for an in-memory database may be higher than a source type factor for a legacy database which uses slower disk access for data retrieval. As such, in the example of FIG. 1, the smart service 128 can compute the source type factor 246 based on characteristics of the data source 131. Other examples of data source characteristics that can affect the value of the source type factor include attributes that indicate whether the data source is an on-premise database, whether the data is stored in the cloud, server type and capacity, etc.

The smart service 128 can also calculate the source type factor 246 based on other factors that may affect data retrieval speed, such as device type of the receiving device (e.g., the client device 104) or characteristics of the network (e.g., the network 106) over which data is sent. The source type factor 246 can be computed dynamically, such as at application load time or otherwise before a first data request. Additionally, the source type factor 246 can be recalculated in response to certain events, such as a network connection change (e.g., going from a wireless to a wired connection or vice versa), a data source change (e.g., connecting to a different type of database), etc.

FIG. 2C illustrates a formula 270 for determining a threshold value 272 at which to request a next data chunk. The threshold value 272 represents a trigger point at which a next chunk is loaded. The smart service 128 of FIG. 1 can determine the threshold value 272 by using a maximum function 274 that determines a maximum of a first parameter and a second parameter. The first parameter evaluated by the maximum function 274 is a result of multiplying a threshold factor 276 by a chunk size 278. The chunk size 278 can be the chunk size 232 described above with respect to FIG. 2B. The threshold factor 276 is a scaling factor that can determine a minimum proportion of entries that a user should scroll through before a next data retrieval occurs. The second parameter evaluated by the maximum function 274 is a result of a ceiling function 280 that returns a smallest integer greater than or equal to a parameter.

The parameter for the ceiling function 280 is an expression 282 that includes a chunk size 284 (which corresponds to the chunk size 278 and the chunk size 232) divided by a scrolling velocity 286 (which corresponds to the scrolling velocity 202) and multiplied by a time window 288. The time window 288 refers to a duration or time interval within which the user's scrolling behavior is observed and analyzed. The time window 288 represents a period over which the system determines the threshold for triggering a call to retrieve a next chunk of data. The time window 288 may be typically defined in milliseconds or seconds and can vary based on a specific application and/or desired behavior. The time window 288 can enable the system to take into account the time taken by the user to scroll through a certain amount of data so as to adjust the threshold 272 accordingly.

FIG. 3 illustrates example actions 300 that may occur during application loading. The actions 300 may be performed in association with loading of the application 108, by the application 108, the smart service 128, and the data service 129. For example, in an action 302, the application 108 can initiate pre-loading of the smart service 128 with default parameters (e.g., time_window, threshold_factor, source_type_factor, etc.) and initial values of each parameter.

In an action 304, the application 108 sends a request to the data service 129 with a query or other data request, where the request includes parameters relevant to the data service 129 (e.g., chunk size and threshold).

In an action 306, the data service 129, in response to the request from the application 108, begins processing of (e.g., retrieval of) an initial data chunk.

In an action 308, the smart service 128 periodically performs computations (e.g., based on a time_window parameter) to update parameters used by the data service (e.g., chunk size and threshold).

In an action 310, the data service 129 sends a requested initial data chunk to the application 108. The application 108 then displays a part of or the entire data chunk.

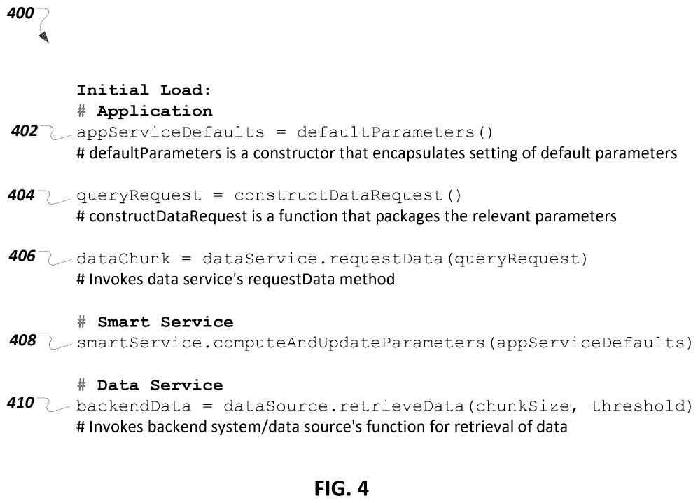

FIG. 4 illustrates example pseudocode 400 for application loading. The example pseudocode corresponds to the example actions 300 described above with respect to FIG. 3. At 402, corresponding to the action 302, the application 108 can invoke a defaultParameters( ) function (e.g., constructor) that encapsulates setting of default parameters.

At 404, corresponding to the action 302, the application 108 can invoke a constructDataRequest( ) function to package relevant parameters for the data service 129.

At 406, corresponding to the action 304, the application 108 can invoke a requestData method of the data service 129 and provide the packaged parameters.

At 408, corresponding to the action 308, the smart service 128 computes and updates parameters (e.g., initially and also periodically), such as scrolling velocity, chunk size, and threshold parameters.

At 410, corresponding to the action 306, the data service 129 invokes a backend data source data retrieval method to retrieve an initial data chunk (e.g., using an initial value for the chunk size parameter).

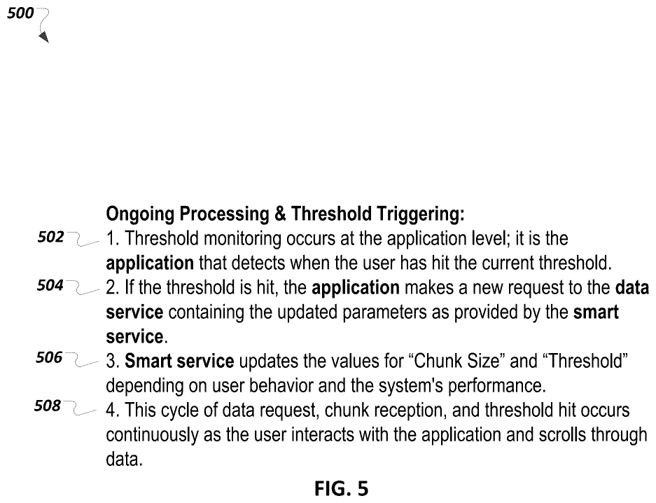

FIG. 5 illustrates example ongoing actions 500 that can occur after an application has loaded. In an action 502, the application 108 can perform threshold monitoring at an application level by detecting when user scrolling has resulted in the user reaching (e.g., viewing) a point in the content corresponding to the current threshold).

In an action 504, in response to the application 108 detecting that the threshold has been hit, the application 108 makes a new request to the data service 129 for a next data chunk, where the request includes updates parameters that may have updated parameter values provided by the smart service 128.

In an action 506, the smart service 128 periodically updates values for chunk size and threshold parameters, based on the user's behavior and the system's performance.

In actions 508, the actions 502, 504, and 506 that represent a cycle of data request, data chunk reception by the application 108, and threshold reaching can occur repeatedly as the user interacts with the application 108 and scrolls through presented data.

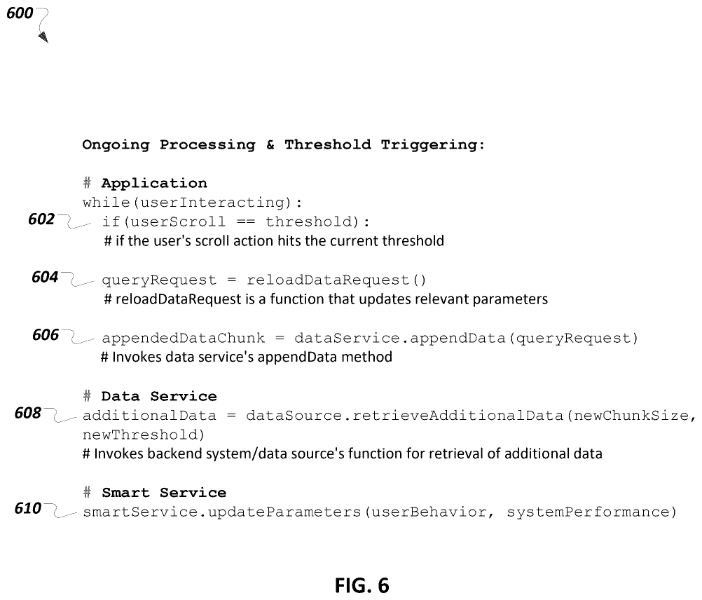

FIG. 6 illustrates example pseudocode 600 that describes code that may be executed after an application has loaded. At 602, corresponding to the action 502, the application 108, while the user is interacting with data presented in the application 108, the application detects that the threshold has been hit.

At 604, corresponding to the action 504, the application 108 invokes a reload data request function to update parameters before a next data request.

At 606, corresponding to the action 504, the application 108 requests next data by invoking an appendData method of the data service 129.

At 608, corresponding to the action 504, the data service 129, in response to the request from the application 108, invokes a backend system or data source function for retrieval of additional data. The retrieved data can be provided to the application 108.

At 610, corresponding to the action 506, the smart service 128 periodically updates parameters, such as chunk size, threshold, or other parameters upon which those parameters are determined (e.g., scrolling velocity, source_type_factor), based on observed user behavior and system performance.

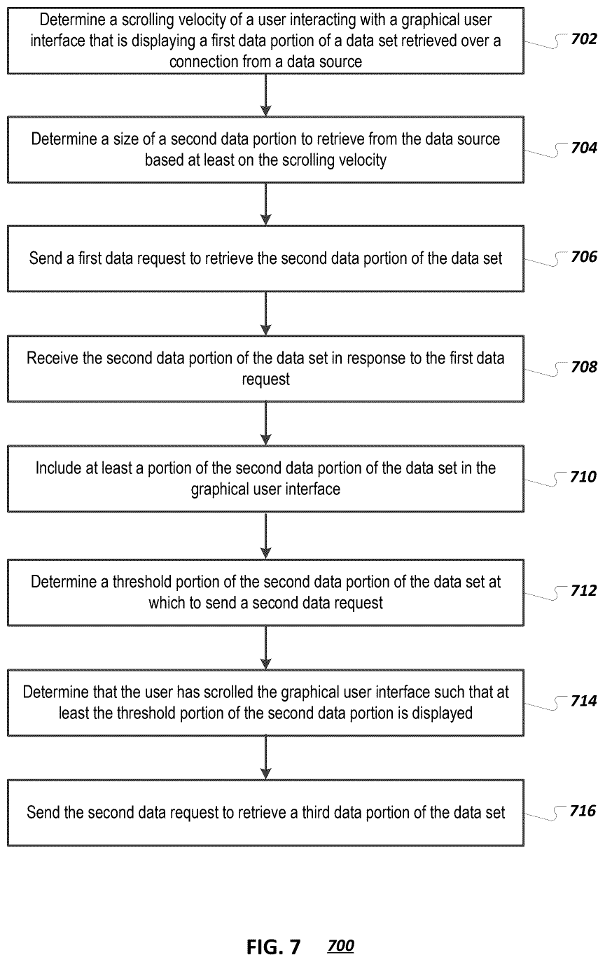

FIG. 7 is a flowchart of an example method for dynamic data chunking and intelligent lazy loading. It will be understood that method 700 and related methods may be performed, for example, by any suitable system, environment, software, and hardware, or a combination of systems, environments, software, and hardware, as appropriate. For example, one or more of a client, a server, or other computing device can be used to execute method 700 and related methods and obtain any data from the memory of a client, the server, or the other computing device. In some implementations, the method 700 and related methods are executed by one or more components of the system 100 described above with respect to FIG. 1.

At 702, a scrolling velocity is determined of a user interacting with a graphical user interface that is displaying a first data portion of a data set retrieved over a connection from a data source. The scrolling velocity can be determined based on a current scroll position in the graphical user interface, a previous scroll position, a current timestamp at which the current scroll position is determined, and a previous timestamp at which the previous scroll position is determined.

At 704, a size of a second data portion to retrieve from the data source is determined, based at least on the scrolling velocity. The size of the second data portion can be determined based on the scrolling velocity, a minimum data portion size, a maximum data portion size, and at least one characteristic of the data source or the connection. A first characteristic of the data source can be a data source location, a database type, a server type, or a storage technology. A first characteristic of the connection can be a connection type, a network type, or a device type of a receiving device. The size of the second data portion can be determined based on a smoothing factor applied to the scrolling velocity. The smoothing factor can be a logarithmic function.

At 706, a first data request is sent to retrieve the second data portion of the data set. The first data request specifies the size of the second data portion.

At 708, the second data portion of the data set is received in response to the first data request.

At 710, at least a portion of the second data portion of the data set is included in the graphical user interface.

At 712, a threshold portion of the second data portion of the data set at which to send a second data request is determined. The threshold portion of the second data portion can be determined based on a minimum threshold, the size of the second data portion, the scrolling velocity, and a user behavior monitoring time interval.

At 714, a determination is made that the user has scrolled the graphical user interface such that at least the threshold portion of the second data portion is displayed; and

At 716, the second data request is sent to retrieve a third data portion of the data set.

User behavior can be monitored between the first data request and the second data request and the scrolling velocity of the user can be updated to an updated scrolling velocity. A size of the third data portion can be determined based at least on the updated scrolling velocity and the size of the third data portion in the second data request.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
determining a scrolling velocity of a user interacting with a graphical user interface that is displaying a first data portion of a data set retrieved over a connection from a data source;
determining a size of a second data portion to retrieve from the data source based at least on the scrolling velocity;
sending a first data request to retrieve the second data portion of the data set, wherein the first data request specifies the size of the second data portion;
receiving the second data portion of the data set in response to the first data request;
including at least a portion of the second data portion of the data set in the graphical user interface;
determining a threshold portion of the second data portion of the data set at which to send a second data request;
determining that the user has scrolled the graphical user interface such that at least the threshold portion of the second data portion is displayed; and
sending the second data request to retrieve a third data portion of the data set.

2. The computer-implemented method of claim 1, wherein the scrolling velocity is determined based on a current scroll position in the graphical user interface, a previous scroll position, a current timestamp at which the current scroll position is determined, and a previous timestamp at which the previous scroll position is determined.

3. The computer-implemented method of claim 1, wherein the size of the second data portion is determined based on the scrolling velocity, a minimum data portion size, a maximum data portion size, and at least one characteristic of the data source or the connection.

4. The computer-implemented method of claim 3, wherein a first characteristic of the data source comprises a data source location, a database type, a server type, or a storage technology.

5. The computer-implemented method of claim 3, wherein a first characteristic of the connection comprises a connection type, a network type, or a device type of a receiving device.

6. The computer-implemented method of claim 1, wherein the size of the second data portion is determined based on a smoothing factor applied to the scrolling velocity.

7. The computer-implemented method of claim 6, wherein the smoothing factor is a logarithmic function.

8. The computer-implemented method of claim 1, wherein the threshold portion of the second data portion is determined based on a minimum threshold, the size of the second data portion, the scrolling velocity, and a user behavior monitoring time interval.

9. The computer-implemented method of claim 1, further comprising monitoring user behavior and updating the scrolling velocity of the user to an updated scrolling velocity.

10. The computer-implemented method of claim 9, further comprising
determining a size of the third data portion based at least on the updated scrolling velocity; and
including the size of the third data portion in the second data request.

11. A system comprising:
one or more computers; and
a computer-readable medium coupled to the one or more computers having instructions stored thereon which, when executed by the one or more computers, cause the one or more computers to perform operations comprising:
determining a scrolling velocity of a user interacting with a graphical user interface that is displaying a first data portion of a data set retrieved over a connection from a data source;
determining a size of a second data portion to retrieve from the data source based at least on the scrolling velocity;
sending a first data request to retrieve the second data portion of the data set, wherein the first data request specifies the size of the second data portion;
receiving the second data portion of the data set in response to the first data request;
including at least a portion of the second data portion of the data set in the graphical user interface;
determining a threshold portion of the second data portion of the data set at which to send a second data request;
determining that the user has scrolled the graphical user interface such that at least the threshold portion of the second data portion is displayed; and
sending the second data request to retrieve a third data portion of the data set.

12. The system of claim 11, wherein the scrolling velocity is determined based on a current scroll position in the graphical user interface, a previous scroll position, a current timestamp at which the current scroll position is determined, and a previous timestamp at which the previous scroll position is determined.

13. The system of claim 11, wherein the size of the second data portion is determined based on the scrolling velocity, a minimum data portion size, a maximum data portion size, and at least one characteristic of the data source or the connection.

14. The system of claim 13, wherein a first characteristic of the data source comprises a data source location, a database type, a server type, or a storage technology.

15. The system of claim 14, wherein a first characteristic of the connection comprises a connection type, a network type, or a device type of a receiving device.

16. A computer program product encoded on a non-transitory storage medium, the product comprising non-transitory, computer readable instructions for causing one or more processors to perform operations comprising:
determining a scrolling velocity of a user interacting with a graphical user interface that is displaying a first data portion of a data set retrieved over a connection from a data source;
determining a size of a second data portion to retrieve from the data source based at least on the scrolling velocity;
sending a first data request to retrieve the second data portion of the data set, wherein the first data request specifies the size of the second data portion;
receiving the second data portion of the data set in response to the first data request;
including at least a portion of the second data portion of the data set in the graphical user interface;
determining a threshold portion of the second data portion of the data set at which to send a second data request;
determining that the user has scrolled the graphical user interface such that at least the threshold portion of the second data portion is displayed; and
sending the second data request to retrieve a third data portion of the data set.

17. The computer program product of claim 16, wherein the scrolling velocity is determined based on a current scroll position in the graphical user interface, a previous scroll position, a current timestamp at which the current scroll position is determined, and a previous timestamp at which the previous scroll position is determined.

18. The computer program product of claim 16, wherein the size of the second data portion is determined based on the scrolling velocity, a minimum data portion size, a maximum data portion size, and at least one characteristic of the data source or the connection.

19. The computer program product of claim 18, wherein a first characteristic of the data source comprises a data source location, a database type, a server type, or a storage technology.

20. The computer program product of claim 19, wherein a first characteristic of the connection comprises a connection type, a network type, or a device type of a receiving device.
